(19) United States
(12) Patent Application Publication
(10) Pub. No.: US 2009/0180520 A1
(43) Pub. Date: Jul. 16, 2009

(54) POSITIONING APPARATUS

(76) Inventor: Yosuke Kobayashi, Kanagawa (JP)

Correspondence Address: MCDERMOTT WILL & EMERY LLP, 600 13TH STREET, NW, WASHINGTON, DC, 20005-3096, US

(21) Appl. No.: 12/349,207

(22) Filed: Jan. 6, 2009

(30) Foreign Application Priority Data
Jan. 10, 2008 (JP) P.2008-003341

(51) Int. Cl. H04B 1/707

(52) U.S. Cl. 375/147; 375/E01.002

(57) ABSTRACT

A positioning apparatus has an oscillator that generates a reproduced carrier wave which keeps track of a carrier wave of a satellite signal; a pseudo noise generator that generates a pseudo noise code unique to a satellite; a control section that controls a phase of the pseudo noise code in accordance with a change in the phase of the reproduced carrier wave, to thus control the pseudo noise generator so as to keep constant a difference between the phase of the pseudo noise code included in a satellite signal and the phase of the pseudo noise code; a timing generation section that generates a timing associated with a rise or fall of the pseudo noise code; a frequency generation section that generates at least one frequency signal; a sampling section that samples an amplitude of the satellite signal by means of a frequency signal; a cumulative addition section that cumulatively adds a signal sampled by the sampling section; and a phase difference computing section that computes a phase difference between the pseudo noise code included in the satellite signal and the pseudo noise code by use of a result of cumulative addition. The frequency generation section selects a frequency signal in synchronism with a timing generated by the timing generation section.

### BACKGROUND OF THE INVENTION

1. Field of the invention

The present invention relates to a positioning apparatus that utilizes a GNSS (Global Navigation Satellite System) satellite, and more particularly, a positioning apparatus that determines a position and speed by utilization of GPS satellites that orbit around the Earth.

2. Description of the related art

A positioning apparatus utilizing a Global Navigation Satellite System (GNSS) employing satellites of a GPS system and a GLONASS system, and the like, simultaneously receives radio waves from a plurality of GNSS satellites and acquires a navigation message (orbit information and time information) from the GNSS satellites, thereby computing an absolute position on the Earth.

In general, a positioning apparatus utilizing satellites simultaneously receives signals from four or more satellites; captures carrier waves and keeps track of pseudo noise codes; and subject the codes to spectrum despread processing, thereby demodulating navigation data from the satellite signals. Further, the positioning apparatus computes times at which the satellites transmitted the signals, by use of the navigation data, and the like, to thus determine pseudo distances to the respective satellites (i.e., times consumed by the satellite signals to arrive at the positioning apparatus), and determines the location of the positioning apparatus from the thus-determined pseudo distances.

In order to keep high-precision track of a pseudo noise code of a satellite signal, Patent Document 1 discloses a method for sampling an amplitude of a satellite signal appearing before and after rising timing of a pseudo noise code of a pseudo noise generator generated by the positioning apparatus and keeping track of the pseudo noise code of the satellite signal by means of a difference between a time at which the amplitude crosses zero and rise timing of the pseudo noise code of the pseudo noise generator.

Patent Document 1: Japanese Patent No. 3231624

However, the previously-described positioning apparatus samples an amplitude of a satellite signal only before and after the rise timing of the pseudo noise code. Hence, when a signal whose signal intensity is deteriorated is tracked indoors, and the like, computation of the time at which the amplitude crosses zero entails an increase in error. Further, noise can be eliminated by extending a time for measuring sampling operation. However, when the measurement time is extended, tracking performance against an external change, such as a Doppler effect induced as a result of movement of a positioning apparatus, is deteriorated.

### SUMMARY OF THE INVENTION

The present invention aims at providing a positioning apparatus that accurately acquires a time at which an amplitude crosses zero even at the time of receipt of a weak signal.

The present invention provides a positioning apparatus comprising:

an oscillator that generates a reproduced carrier wave which keeps track of a carrier wave of a satellite signal;

a pseudo noise generator that generates a pseudo noise code unique to a satellite;

a control section that controls a phase of the pseudo noise code, which is generated from the pseudo noise generator, in accordance with a change in the phase of the reproduced carrier wave generated from the oscillator, to thus control the pseudo noise generator so as to keep constant a difference between the phase of the pseudo noise code included in a satellite signal and the phase of the pseudo noise code generated from the pseudo noise generator;

a timing generation section that generates a timing associated with a rise or fall of the pseudo noise code generated by the pseudo noise generator;

a frequency generation section that generates at least one frequency signal;

a sampling section that samples an amplitude of the satellite signal by means of a frequency signal generated by the frequency generation section;

a cumulative addition section that cumulatively adds a signal sampled by the sampling section; and

a phase difference computing section that computes a phase difference between the pseudo noise code included in the satellite signal and the pseudo noise code, which is generated by the pseudo noise generator, by use of a result of cumulative addition acquired in the cumulative addition section, wherein the frequency generation section selects a frequency signal in synchronism with a timing generated by the timing generation section.

In the positioning apparatus, the frequency generation section generates a frequency signal having a frequency determined by multiplying or dividing a frequency signal from a single reference frequency source.

In the positioning apparatus, the sampling section outputs a value determined by averaging a plurality of sampled signals in synchronism with a timing generated by the timing generation section.

The positioning apparatus further includes an adder for counting outputs from a plurality of timing generation sections, and the frequency generation section selects a frequency signal by use of a value output from the adder.

The positioning apparatus of the present invention reduces influence of noise by increasing the number of samples only before and after a timing at which a pseudo noise code changes. Hence, even when a weak signal is received, highly-accurate measurement exclusive of influence of a multipath can be performed. Consequently, even when a weak signal is received, a time at which an amplitude crosses zero can be acquired with superior accuracy.

### BRIEF DESCRIPTION OF THE DRAWINGS

FIG. 1 is a block diagram showing a positioning apparatus of a first embodiment;

FIG. 2 is a block diagram showing the internal configuration of a correlator of the first embodiment;

FIG. 3 is a characteristic view showing a relationship between a phase difference and a change in amplitude acquired by means of measurement of an amplitude of a satellite signal;

FIG. 4 is a view showing a change in amplitude acquired when a received signal is sampled in association with a pseudo noise code;

FIG. 5 is a view showing a change in an amplitude acquired when a sampling frequency is increased;

FIG. 6 is a view showing a change in an amplitude acquired when a sampled amplitude is averaged before and after a change timing;

FIG. 7 is a block diagram showing a positioning apparatus of a second embodiment; and

FIG. 8 is a block diagram showing the internal configuration of a correlator of the second embodiment.

### DESCRIPTION OF THE PREFERRED EMBODIMENTS

Embodiments of the present invention will be described hereunder by reference to the drawings.

### First Embodiment

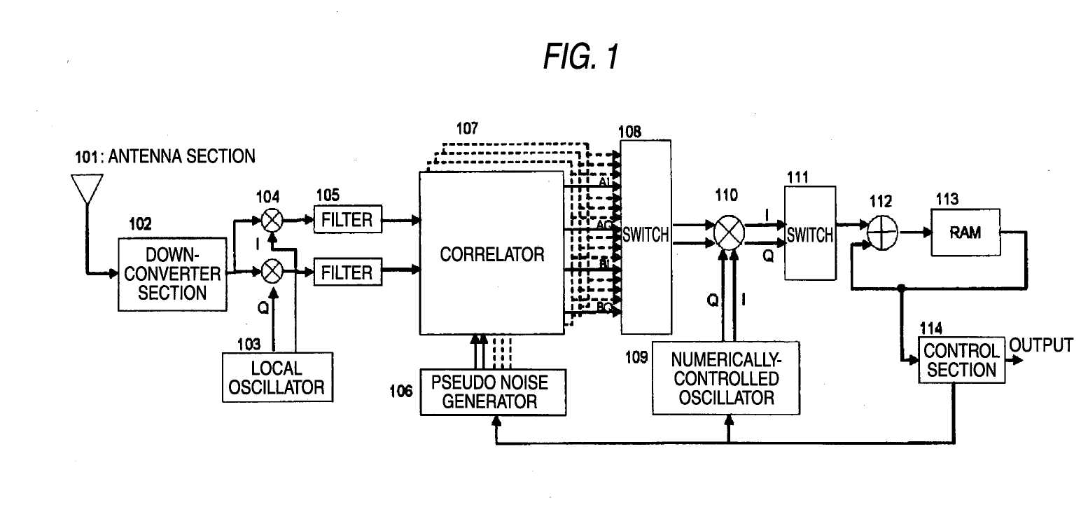

FIG. 1 is a block diagram showing a positioning apparatus of a first embodiment. As shown in FIG. 1, a positioning apparatus of the first embodiment has an antenna section 101; a down-converter section 102; a local oscillator 103; a mixer 104; low-pass filters 105; a pseudo noise generator 106; correlators 107; a switch 108; a numerically-controlled oscillator 109; a mixer 110; a switch 111; an adder 112; RAM 113; and a control section 114.

The antenna section 101 receives a satellite signal. The down-converter section 102 down-converts the signal received by the antenna section 101 to an intermediate frequency. The local oscillator 103 outputs a reference frequency signal. The mixer 104 performs frequency-conversion of the intermediate frequency signal into a base band. The low-pass filter 105 lowers a sampling frequency. The pseudo noise generator 106 generates a pseudo noise code unique to a satellite from which the signal is received. In connection with each of the plurality of satellites, each of the correlators 107 mixes a satellite signal with an output from the pseudo noise generator 106 and subjects a resultant to time quadrature for a given period, to thus determine a correlation. The switch 108 produces an output by means of switching, in a time-ordered manner, outputs from the correlators 107 subjected to time quadrature on a per-satellite basis.

The numerically controlled oscillator 109 outputs, in a time-ordered manner, a reproduced carrier wave matching a carrier wave frequency of a satellite signal in synchronism with the satellite signal output from the switch 108. The mixer 110 performs frequency conversion so as to eliminate a carrier wave component of the satellite signal from the output of the correlator 107. The switch 111 produces an output by means of sequentially switching outputs I and Q from the mixer 110. The adder 112 cumulatively adds outputs from the mixer 110 on a per-satellite basis. The RAM 113 cumulatively stores an output from the adder 112. The control section 114 controls the pseudo noise generator 106 and the numerically-controlled oscillator 109 for each satellite signal so as to track the satellite signal by use of a result determined by cumulative addition of the in-phase component I and the quadrature component Q.

Operation of the positioning apparatus of the first embodiment will be described. The antenna section 101 receives a satellite signal. The down-converter section 102 performs down-conversion of the satellite signal into an intermediate frequency signal and A-D conversion of the intermediate frequency signal. The mixer 104 multiplies the A-D-converted intermediate frequency signal by an I signal output from the local transmitter 103 and a Q signal that is 90° out of phase with the I signal, thereby performing quadrature frequency conversion. The pseudo noise generator 106 generates a pseudo noise code unique to a satellite from which a signal is received.

A received signal is despread by means of a pseudo noise code output from the pseudo noise generator 106. Results of despreading operation are subjected to time quadrature in the correlators 107, whereby smoothed signals AI and AQ are output. Further, each of the correlators 107 samples the received signal at a timing prior or subsequent to, by only the timing δ, a timing at which the pseudo noise code generated by the pseudo noise generator 106 changes from zero to one or from one to zero, and signals BI and BQ determined by means of smoothing a sample value by means of time quadrature are output. In subsequent circuitry, a plurality of satellite signals are subjected to time division processing by means of a single circuit configuration, and hence the switch 108 switches, in a time-ordered manner, outputs from a plurality of correlators, to thus produce an output. The numerically controlled oscillator 109 transmits a reproduced carrier wave signal for each satellite and outputs quadrature output signals I and Q.

The mixer 110 performs quadrature frequency conversion of the signal output from the correlator 107 in a time-division manner, by use of signals AI, AQ, BI, and BQ output from the correlator 107 by the switch 108 in a time-ordered manner through use of signals I and Q output from the numerically-controlled oscillator 109, thereby eliminating a carrier wave component from the signal output from the correlator 107. The adder 112 performs cumulative addition of the signals AI, AQ, BI, and BQ output from the mixer 110 on a per-satellite basis and stores a cumulatively added value into the RAM 113.

The control section 114 controls the numerically-controlled oscillator 109 in such a way as to make the signal AI large and the signal AQ close to zero by use of the cumulatively-added value of the signal AI and the cumulatively-added value of the signal AQ stored in the RAM 113. The control section 114 measures an average value of the signal BI by means of changing the value of 6 and searches the value of 6 at which a measured value becomes smaller, thereby measuring a phase difference between the pseudo noise code of the pseudo noise generator 106 and the pseudo noise code of the satellite signal. The thus-measured phase difference is added to a phase set on the pseudo noise generator 106, whereby the phase of the pseudo noise code included in the satellite signal is measured. Further, the control section 114 demodulates a navigation message transmitted from the satellite by means of a change in a sign of the cumulatively added value of the signal AI. A time at which the satellite transmitted the radio waves is determined from the phase of the measured pseudo noise code and the timing of data pertaining to the navigation message. Further, the control section 114 computes the position of the antenna of the positioning apparatus through use of orbit information and time information, which have been received in connection with the plurality of satellites, and the measured times; and outputs the thus-computed antenna position to the outside.

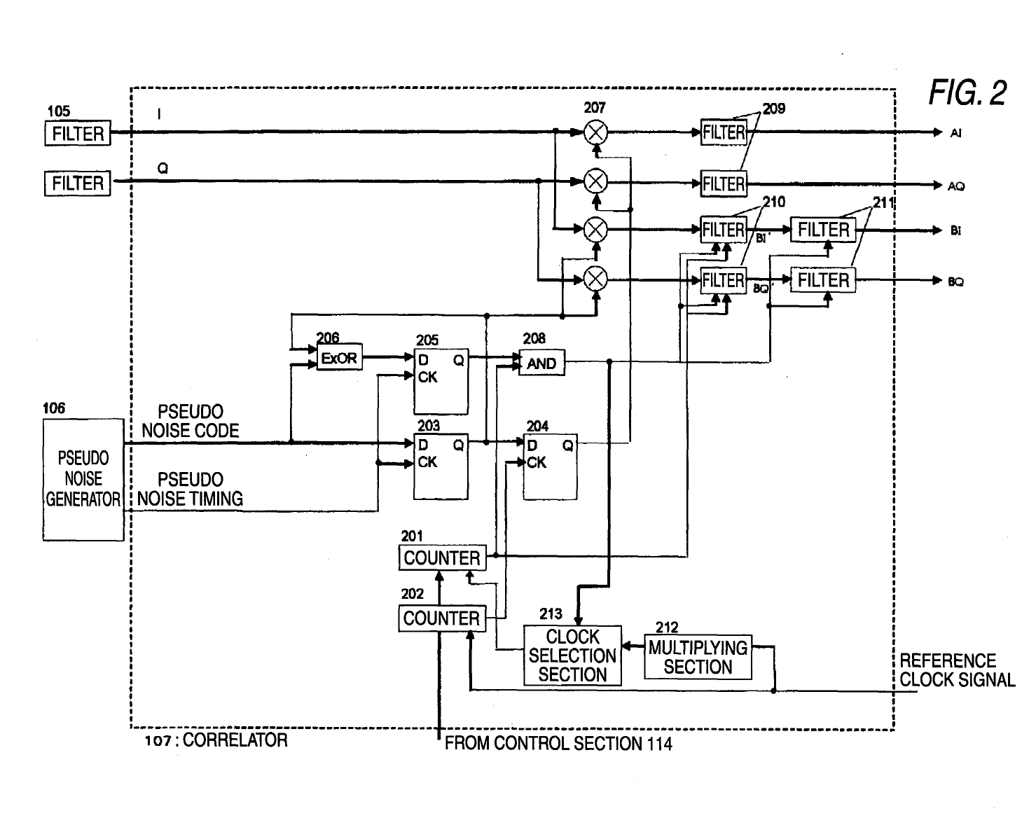

Operation of the correlator 107 will be described hereinbelow by reference FIG. 2. FIG. 2 is a block diagram showing the internal configuration of the correlator of the first embodiment.

In FIG. 2, a counter 201 starts counting operation by means of taking, as a sign, a timing signal prior to the pseudo noise code generated by the pseudo noise generator 106 and generates timing that is prior or subsequent to, by only a period of the timing δ, the timing of the pseudo noise code. A counter 202 generates a timing at which the pseudo noise code generated by the pseudo noise generator 106 changes. A D-latch 203 latches the pseudo noise code generated by the pseudo noise generator 106 for a period of one chip. A D-latch 204 latches, for a period of one chip, the pseudo noise code generated by the pseudo noise generator 106 in synchronism with the timing at which the counter 202 produces an output. The pseudo noise code output from the D-latch 203 matches with the pseudo noise code generated by the pseudo noise code generator 106. A D-latch 205 latches a signal, which represents a change in the pseudo noise code from zero to one or from one to zero, for about one-half the period of one chip before and after the timing at which the pseudo noise code changes.

A logic circuit 206 outputs one only when the pseudo noise code is different from the value of the pseudo noise code achieved at the timing before one chip. Each of mixers 207 inverts the sign of a signal output from the filter 105 depending on whether the pseudo noise code, which is output from the latch 202 and which has the same timing as that of the pseudo noise code generator 106, is one or zero. An AND gate 208 outputs only a timing at which the pseudo noise code changes from zero to one or from one to zero, among the timings output from the counter 201, to a filter 209. The filter 209 outputs respective outputs signals AI and AQ smoothed by subjecting outputs from the respective mixers 207 to time quadrature. Filters 210 output, in synchronism with an output timing of the AND gate 208, signals BI′ and BQ′ smoothed by subjecting the outputs from the filters 105 to time quadrature. Filters 211 average a plurality of signals BI′ and BQ′ output from the filters 210 and output the resultant averages as signals BI and BQ. A multiplying section 212 subjects a reference clock signal to frequency conversion, thereby outputting a clock signal whose frequency is determined by multiplying the frequency of the reference clock signal by an integer. A clock selection section 213 outputs a clock signal of the multiplying section 212 at a timing at which the pseudo noise code output from the AND gate 208 changes from zero to one or from one to zero, and outputs a reference clock signal at a timing other than the change timing.

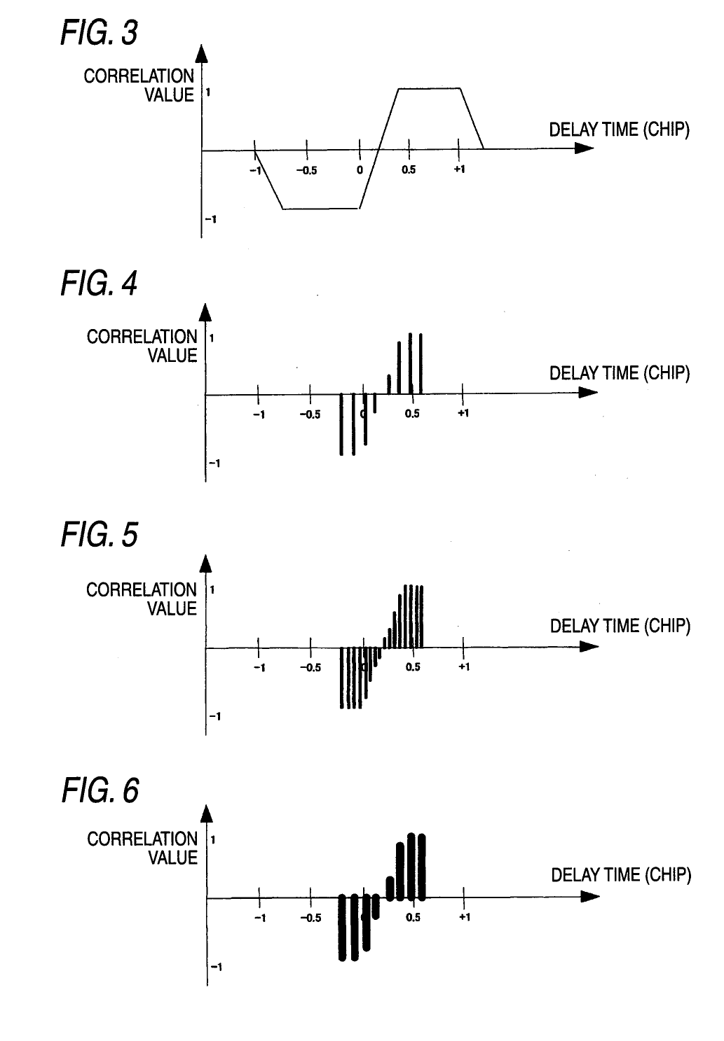

Operations of the correlators 107 will be described hereunder in detail by reference to FIGS. 3 through 6.

FIG. 3 shows a change in an amplitude of the signal BI that is a result of cumulative addition of the signal BI stored in the RAM 113 and that is acquired when the timing δ of the counter 201 is changed by means of taking, as a reference, the timing at which the pseudo noise generator 106 generates a pseudo noise code. A carrier wave component is eliminated from the result of cumulative addition of the signal BI by the numerically-controlled oscillator 109, and hence an essentially-constant positive or negative amplitude is achieved during a period of one chip before or after the timing at which the pseudo noise code of the satellite signal changes from zero to one or from one to zero. An inclination in amplitude change is attributable to band limitation imposed on a satellite signal and a frequency characteristic of the down-converter section 102. At a time in excess of the period of one chip before and after the change timing, no correlation exists between the timing at which the AND gate 208 outputs a signal and the state of a pseudo noise code included in a satellite signal being received, and hence an amplitude assumes a value of zero.

FIG. 4 shows a change in the amplitude of the signal BI acquired when the value of δ is quantized at the timing when the counter 201 produces an output. In order to search a location where the amplitude crosses zero, the control section 114 determines a value at which the sign of a value of a change in the amplitude of the signal BI is inverted, by use of the least square method, or the like; and determines the value as a phase difference between the pseudo noise code of the pseudo noise generator 106 and the pseudo noise code of the satellite signal. The thus-determined phase difference is applied to the phase set on the pseudo noise generator 106, whereby the phase of the pseudo noise code included in the satellite signal can be measured.

FIG. 5 shows a change in the amplitude of the signal BI′ acquired when the signal is quantized, only at the timing when the AND gate 208 outputs a signal, by means of the clock signal that is multiplied by the multiplying section 212 by a factor of N. The clock selection section outputs, only at the timing when the pseudo noise code changes from zero to one or from one to zero, a clock signal determined by multiplying the reference clock signal output from the multiplying section 212 by a factor of N. The counter 101 outputs, at the timing that is prior or subsequent to the timing of the pseudo noise code by only the timing δ, the N number of timing signals acquired before and after the timing δ through use of the clock signal multiplied by a factor of N. The N number of samples are subjected to time quadrature by means of the filter 210, and smoothed signals BI1 to BIN and BQ1 to BQN are output as the signals BI′ and BQ′ in a time-ordered manner.

FIG. 6 shows a change in the amplitude of the signal BI acquired when the filter 211 averages the sampled amplitude. The filter 211 processes, in a time-ordered manner, the signals BI′ and BQ′ output from the filter 210, thereby adding the N number of signals BI′ and the N number of signals BQ′. Values determined by dividing results of addition by the numeral N at a timing when the N number of samples are collected are output as the signals BI and BQ in synchronism with the reference clock signal. Since the signals BI′ and BQ′ are signals determined by sampling the signals, which are output from the filters 105 at the timing when the pseudo noise code changes from zero to one or from one to zero, by means of a clock signal multiplied by a factor of N, the signals BI and BQ divided by the numeral N turn into averages of samples acquired by sampling the signals output from the filters 105 at a plurality of points. As a result of the signals sampled at the plurality of points being averaged, a white noise component is multiplied by a factor of one-Nth, and the signal component still remains one time as large as its original magnitude. Therefore, a signal-to-noise ratio can be increased. Further, the filter 211 outputs a value, which is divided by N, in synchronism with the reference clock signal. Hence, the circuits subsequent to the switch 108 can operate in synchronism with the reference clock signal. In general, when the clock signal is increased, power consumption also increases. For this reason, the smaller the number of circuits that operate by means of the signal multiplied by a factor of N, the greater reduction of an increase in power consumption.

The present embodiment has been described by reference to the configuration in which the multiplying section 212 is provided in each of the correlators 107. However, when another multiplying section is present in the positioning apparatus, the multiplying section can also be used in a shared manner.

As mentioned above, in the present embodiment, the influence of noise is reduced by increasing the number of samples achieved only before and after the change timing of the pseudo noise code, whereby high-precision measurement can be performed by elimination of the influence of a multipath even at the time of receipt of weak signals. Further, since the number of samples is not increased at timings other than the change timing of the pseudo noise code, an increase in power consumption can be prevented. Moreover, a value determined by averaging a plurality of sampled signals is output in synchronism with the timing at which the timing generation means generates timing. Therefore, circuitry whose operation frequency becomes faster can be limited, and hence an increase in power consumption can be prevented.

### Second Embodiment

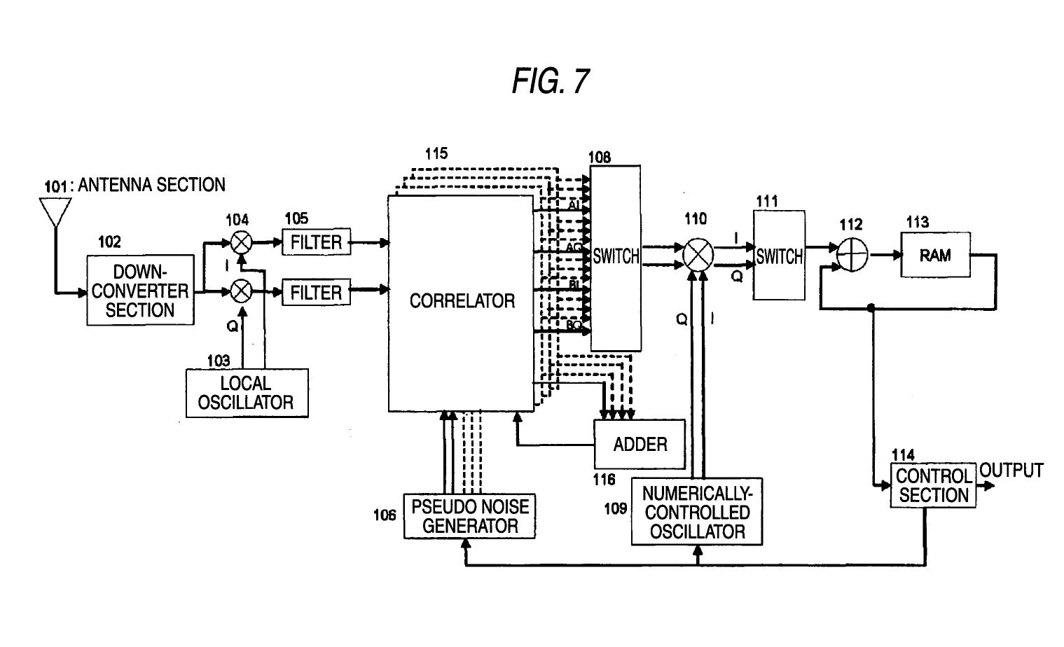

FIG. 7 is a block diagram showing a positioning apparatus of a second embodiment. As shown in FIG. 7, the positioning apparatus of the second embodiment has the antenna section 101, the down-converter section 102, the local oscillator 103, the mixer 104, the low-pass filter 105, the pseudo noise generator 106, correlators 115, the switch 108, the numerically-controlled oscillator 109, the mixer 110, the switch 111, the adder 112, the RAM 113, the control section 114, and the adder 116.

The antenna section 101 receives a satellite signal. The down-converter section 102 down-converts the signal received by the antenna section 101 to an intermediate frequency. The local oscillator 103 outputs a reference frequency signal. The mixer 104 performs frequency-conversion of the intermediate frequency signal into a base band. The low-pass filter 105 lowers a sampling frequency. The pseudo noise generator 106 generates a pseudo noise code unique to a satellite from which the signal is received. In connection with each of the plurality of satellites, each of the correlators 115 mixes a satellite signal with an output from the pseudo noise generator 106 and subjects a resultant to time quadrature for a given period, to thus determine a correlation. The switch 108 produces an output by means of switching, in a time-ordered manner, outputs from the correlators 115 subjected to time quadrature on a per-satellite basis.

The numerically controlled oscillator 109 outputs, in a time-ordered manner, a reproduced carrier wave matching a carrier wave frequency of a satellite signal in synchronism with the satellite signal output from the switch 108. The mixer 110 performs frequency conversion so as to eliminate a carrier wave component of the satellite signal from an output from the correlator 115. The switch 111 produces an output by means of sequentially switching outputs I and Q from the mixer 110. The adder 112 cumulatively adds outputs from the mixer 110 on a per-satellite basis. The RAM 113 cumulatively stores an output from the adder 112. The control section 114 controls the pseudo noise generator 106 and the numerically-controlled oscillator 109 for each satellite signal so as to track the satellite signal by use of a result determined by means of cumulative addition of the in-phase component I and the quadrature component Q. The adder 116 computes the number of signals output from the AND gates of the correlators 115.

In FIG. 7, reference numerals 101 through 114 designate the elements having configurations analogous to those described in connection with the first embodiment by reference to FIG. 1, and hence their explanations are omitted. The correlator 115 corresponds to the correlator 107 that has been described in connection with the first embodiment and that is additionally provided with a function of outputting a timing signal output from the AND gate 208 to the adder 116 and a function of controlling operation of the clock selection section by means of a signal output from the adder 116. The adder 116 is an adder that counts timing signals of AND gates output from the correlators 115 and that outputs counts to the correlators 115.

The adder 116 counts the number of the timing signals simultaneously output from the AND gates of the plurality of correlators and counts a maximum of M timing signals in a positioning apparatus having the M number of correlators. Signals transmitted from the satellites are output at a timing common to all of the satellites. Hence, a coincidence exists in timings at which the pseudo noise codes change in terms of a time at which the satellites transmit signals. However, propagation distances over which the satellite signals arrive at the positioning apparatus vary from one satellite to another. Hence, in terms of a time at which the positioning apparatus receives signals, the timings at which the pseudo noise codes change do not always coincide with each other.

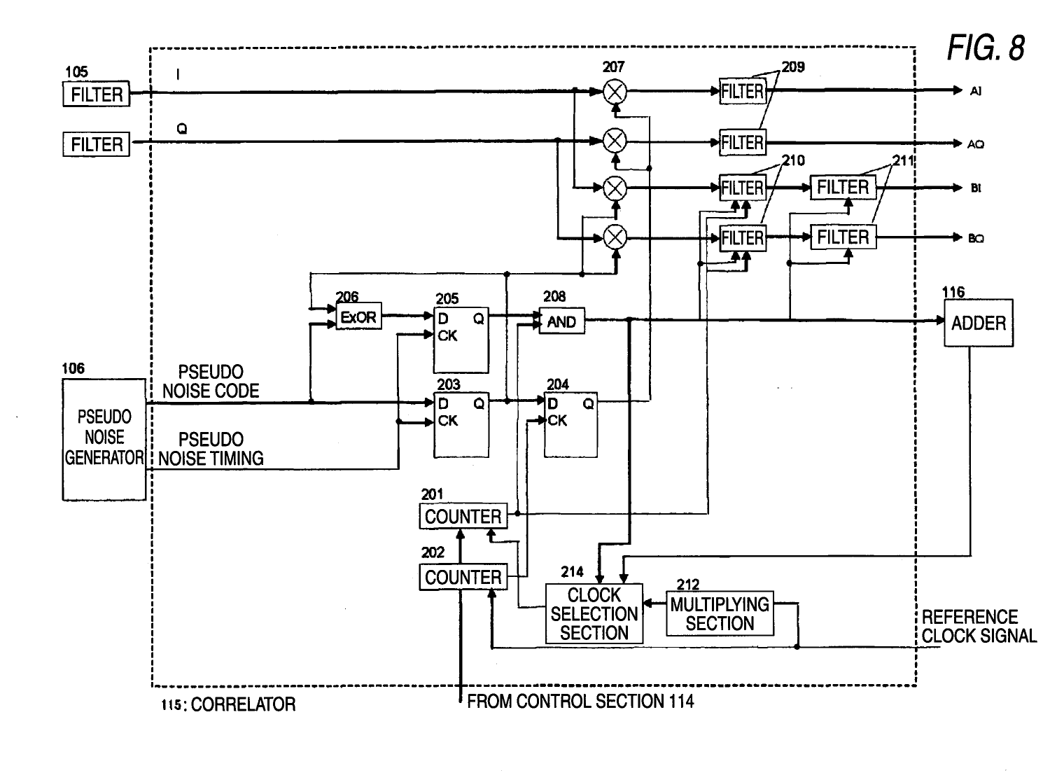

Operation of the correlator 115 will be described hereinbelow by reference FIG. 8. FIG. 8 is a block diagram showing the internal configuration of the correlator of the second embodiment.

In FIG. 8, the counter 201 starts counting operation by means of taking, as a sign, a timing signal prior to the pseudo noise code generated by the pseudo noise generator 106 and generates timing that is prior or subsequent to, by only a period of the timing δ, the timing of the pseudo noise code. The counter 202 generates a timing at which the pseudo noise code generated by the pseudo noise generator 106 changes. The D-latch 203 latches the pseudo noise code generated by the pseudo noise generator 106 for a period of one chip. The D-latch 204 latches, for a period of one chip, the pseudo noise code generated by the pseudo noise generator 106 in synchronism with the timing at which the counter 202 produces an output. The pseudo noise code output from the D-latch 203 matches with the pseudo noise code generated by the pseudo noise code generator 106. The D-latch 205 latches a signal, which represents a change in the pseudo noise code from zero to one or from one to zero, for about one-half the period of one chip before and after the timing at which the pseudo noise code changes.

The logic circuit 206 outputs one only when the pseudo noise code is different from the value of the pseudo noise code achieved at the timing before one chip. Each of mixers 207 inverts the sign of a signal output from the filter 105 depending on whether the pseudo noise code, which is output from the latch 202 and which has the same timing as that of the pseudo noise code generator 106, is one or zero. The AND gate 208 outputs only a timing at which the pseudo noise code changes from zero to one or from one to zero, among the timings output from the counter 201, to the filter 209. The filter 209 outputs the respective outputs signals AI and AQ that are generated by smoothing outputs from the respective mixers 207 through time quadrature. The filters 210 output, in synchronism with the output timing of the AND gate 208, signals BI′ and BQ′ smoothed by subjecting the outputs from the filters 105 to time quadrature. The filters 211 average a plurality of signals B′ and BQ′ output from the filters 210 and output the resultant averages as signals BI and BQ. The multiplying section 212 subjects a reference clock signal to frequency conversion, thereby outputting a clock signal whose frequency is determined by multiplying the frequency of the reference clock signal by an integer. When the value output from the adder 116 is a given value or less, a clock selection section 214 outputs a clock signal of the multiplying section 212 at a timing at which the pseudo noise code output from the AND gate 208 changes from zero to one or from one to zero and outputs a reference clock signal at a timing other than the change timing.

In FIG. 8, reference numerals 201 through 212 designate the elements whose configurations are the same as those of the correlator 107 described in connection with the first embodiment by reference to FIG. 2, and hence their explanations are omitted.

In the plurality of correlation sections that process a plurality of satellite signals, the maximum number M at which multiplied clock signals are simultaneously output is previously set for the clock selection sections 214. In general, the positioning apparatus can perform positioning operation by means of a minimum number of four satellite signals, and therefore selection of a value of four or thereabout is desirable. Next, a value output from the adder 116 is compared with the maximum number M at the timing when the AND gate 208 outputs a signal and when the pseudo noise code changes from zero to one or from one to zero. When the value output from the adder is smaller than the maximum number M, there is output the clock signal that is output from the multiplying section 212 and that is generated by multiplying the reference clock signal by a factor of N. When the value output from the adder is equal to or greater than the maximum number M, the reference clock signal is output.

The clock selection sections of the present embodiment are described as being configured in such a way that the maximum number M is previously determined; however, the clock selection sections may also be configured such that the maximum number M is arbitrarily changed. Moreover, when the number of correlators that simultaneously operate in accordance with a multiplied clock signal is large, the clock selection sections are configured to operate in accordance with an unmultiplied reference clock signal. However, the clock selection sections may also be configured so as to assign weights to the correlators such that a correlator assigned a satellite signal having a low degree of signal intensity operates with priority in accordance with a multiplied clock signal.

As mentioned above, in the present embodiments, the number of correlators that operate in accordance with a multiplied clock signal is controlled, and therefore a peak value of power consumption can be reduced.

The positioning apparatus of the present invention is useful as a positioning apparatus, such as a navigation system. Further, in addition to being useful for an L1-band signal, an L2-band signal, and an L5-band signal of the GPS, the positioning apparatus is useful as a positioning apparatus for use with a satellite navigation system for which signals are modulated by means of a variety of frequencies or codes, such as GALILEO of the EU.

What is claimed is:

1. A positioning apparatus, comprising:
an oscillator generating a reproduced carrier wave which keeps track of a carrier wave of a satellite signal;
a pseudo noise generator generating a pseudo noise code unique to a satellite;
a control section controlling a phase of the pseudo noise code, which is generated from the pseudo noise generator, in accordance with a change in the phase of the reproduced carrier wave generated from the oscillator, to thus control the pseudo noise generator so as to keep constant a difference between the phase of the pseudo noise code included in a satellite signal and the phase of the pseudo noise code generated from the pseudo noise generator;
a timing generation section generating a timing associated with a rise or fall of the pseudo noise code generated by the pseudo noise generator;
a frequency generation section generating at least one frequency signal;
a sampling section sampling an amplitude of the satellite signal by means of a frequency signal generated by the frequency generation section;
a cumulative addition section cumulatively adding a signal sampled by the sampling section; and
a phase difference computing section computing a phase difference between the pseudo noise code included in the satellite signal and the pseudo noise code, which is generated by the pseudo noise generator, by use of a result of cumulative addition acquired in the cumulative addition section, wherein the frequency generation section selects a frequency signal in synchronism with a timing generated by the timing generation section.

2. The positioning apparatus according to claim 1, wherein the frequency generation section generates a frequency signal having a frequency determined by multiplying or dividing a frequency signal from a single reference frequency source.

3. The positioning apparatus according to claim 1, wherein the sampling section outputs a value determined by averaging a plurality of sampled signals in synchronism with a timing generated by the timing generation section.

4. The positioning apparatus according to claim 1, further comprising:
an adder counting outputs from a plurality of timing generation sections,
wherein the frequency generation section selects a frequency signal by use of a value output from the adder.
